(19) United States
(12) Patent Application Publication
(10) Pub. No.: US 2023/0206349 A1
(43) Pub. Date: Jun. 29, 2023

(54) Methods for determining group membership in access control systems

(71) Applicants: David Guo, Fremont, CA (US); Eric Guo, Fremont, CA (US)

(72) Inventors: David Guo, Fremont, CA (US); Eric Guo, Fremont, CA (US)

(21) Appl. No.: 17/561,974

(22) Filed: Dec. 26, 2021

(51) Int. Cl. G06Q 50/00

(52) U.S. Cl. CPC G06Q 50/01

(57) ABSTRACT

To answer if a user is a transitive member of a group efficiently, a method to maintain each node's ancestors or descendants is disclosed. The system maintains each node's ancestor paths or descendant paths and update affected nodes when a child node is added to or removed from the parent node. The affected nodes are the child and the child's descendants in the case of ancestor paths. The affected nodes are the parent and the parent's ancestors in the case of descendant paths. The node's ancestors or descendants are the unique nodes in the ancestor paths or descendant paths. Hybrid approaches can be used to reduce change volumes by skipping users.

### BACKGROUND OF THE INVENTION

### 1. Field of the Invention

The invention relates to access control systems that utilize groups to manage users. In particular, this invention relates how to efficiently determine if a user is a direct or indirect member of a group by maintaining a group/user's ancestors or descendants.

### 2. Description of the Related Art

In today's world, it is very common that multiple people collaborate on the same resources. The resources are hosted centrally. Administrators control which user can access what resources. This is the access control in computer systems.

To ease the user management in access control, a popular practice is to put users into groups. A group is a collection of users. AWS, Google Cloud, and Microsoft Azure all adopted such technology. Assigning access to groups instead of users has the following benefits:
a. When a user joins or leaves a team, the administrators don't need to figure out all the resources that the user may have access to and update all the policies. Instead, the administrators only need to add or remove the user from few groups, e.g., the team groups.
b. When a resource owner needs to share the resource, they can share with a group and delegate the group member management to somebody else without delegating the whole policy.

To further ease the user management, groups can include groups in addition to users. This is called nested groups. Below is an example how nested groups can simplify access management.

In FIG. 1, the production group includes the operator group and the developer group. The development group include developer group and external developer group. With nested groups, the developer group can be reused in both the production group and the development group. Users in developer group will be able to access both the production resources and the development resources. Without nested groups, users in the developer group would need to be added twice: one to the production group and the other to the development group. This increases the management overhead and potential access errors when developers join or leave the team.

While nested groups ease the user management, it takes longer time to determine if a user is a direct or indirect (i.e., transitive) member of a group. For example, to determine if user A is a transitive member of production group, we need to determine if there is a path between user A and the production group. The path could be via the developer group or the operator group. With complicated relationships, the group nest chain could be pretty long. Traversing the graph to find a path takes longer and unpredictable time.

Furthermore, nested groups could introduce loops. For example, group A include group B and group B includes group A. We need to define what it means and make the system work if it happens.

As checking whether a user is a transitive member of a group is a necessary step for every access to a resource, it is highly desirable to make this operation efficient and predictable. This invention is to present a method to allow the system to determine in a predictable and efficient way if there is a path between a user A and a group B, or put another way, if a user A is a transitive member of a group B.

### SUMMARY OF THE INVENTION

Various embodiments of methods for efficiently creating the supporting data in group management systems are contemplated.

In one embodiment, all users and groups' ancestors are generated. Ancestors of group or user A are defined as the groups who directly or indirectly include group A or user A. These higher-level groups are the ancestors of group A or user A. In FIG. 1, user A's ancestors are developer group, production group, and development group.

In another embodiment, all groups' descendants are generated. Descendants of group A are defined as the groups or users who are direct or indirect members of group A. These lower-level groups and users are the descendants of group A. In FIG. 1, the production group's descendants are operator group, developer group, and user A.

In yet another embodiment, it could be a hybrid of the above two. For example, it can be that only groups' ancestors are generated. Users' ancestors can be skipped. For another example, it can be that groups' descendants only include groups and the users are not counted as descendants.

To generate the ancestors or the descendants, each node (a group or a user) maintains a list of paths to its ancestors or descendants.

The following is the method to generate each node's ancestors. When group A or user A is added to group B, B's ancestor paths are added A's descendants. When group A or user A is removed from group B, B's ancestor paths are removed from A's descendants. This will generate a complete list of paths to all ancestors for every node in the graph. Each node can generate its set of ancestors based on the ancestor paths.

When each node has its set of ancestors, it is only one step to determine if user A is a transitive member of group B: just check if group B is in user A's ancestors.

The following is the method to generate each node's descendants. When group A or user A is added to group B, A's descendant paths are added B's ancestors. When a group A or a user A is removed from a group B, A's descendant paths are removed from B's ancestors. This will generate a complete list of paths to all descendants for every node in the graph. Each node can generate its set of descendants based on the descendant paths.

When each node has its set of descendants, it is only one step to determine if a user A is a transitive member of group B: just check if user A is in group B's descendants.

### BRIEF DESCRIPTION OF DRAWING

FIG. 1 illustrates how nested groups can make access management easy.

FIG. 2 illustrates an example set of groups, users, and each node's ancestor paths. When group 203 is added as a member to group 202, it demonstrates how the system updates the affected nodes' ancestor paths.

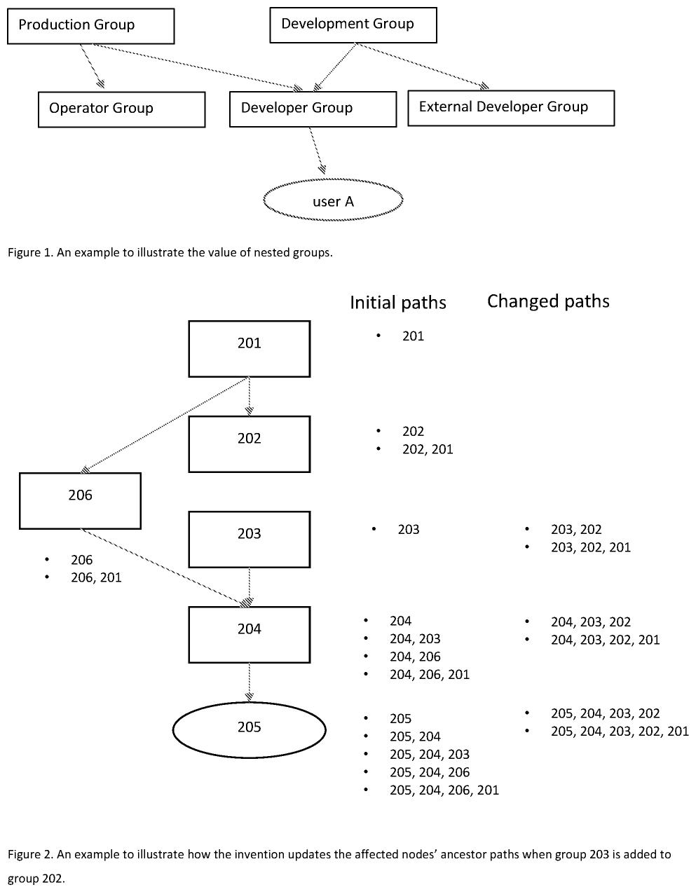

### DETAILED DESCRIPTION OF THE INVENTION

In the following description, numerous specific details are set forth to provide a thorough understanding of the methods and mechanisms presented herein. However, one having ordinary skill in the art should recognize that the various embodiments may be practiced without these specific details.

FIG. 2 is one example groups and users. A group is a collection of groups and/or users. The rectangles mean groups (group 201, 202, 203, 204, 206). The ovals mean users (user 205). The arrow means include or has a member, e.g., group 201 includes/has group 202. Group 201 is the parent of group 202. Group 202 is the child/member of group 201. Both groups and users are nodes. All the nodes and the arrows/edges create a graph. The ancestors of a node are the direct or indirect parents that include this node. For example, user 205's ancestors are group 204, 203, 206, 201. The descendants of a group are the direct or indirect children (groups and/or users) that it includes. For example, group 201's descendants are group 202, 206, 204, and user 205. In FIG. 2, on the side of each node, we listed the paths to reach their ancestors. For convenience, we listed the node itself as a path just to make the following updates easier to understand. For example, group 204 has 3 ancestors: 203, 206, and 201. The paths to reaches them are (203), (206), and (206, 201), respectively.

A group can have multiple direct children. A group or a user can have multiple direct parents. The relationship between parent and child is many to many.

In the following example, we will illustrate how to compute each node's ancestors when a group or a user is added to or removed from its parent.

When group 203 is added to group 202, parent node 202's ancestor paths are added to its new child node 203. As illustrated in the “Changed paths” column in FIG. 2, node 202's paths (202) (202, 201) are added to node 3's paths.

Once a node's paths change, the change needs to be propagated to its children recursively. Thus node 203 will update node 204 and node 204 will update node 205 until there is no descendants to update.

For any node, its ancestors are the unique nodes in its ancestor paths. For example, node 205's ancestors are 204, 203, 206, and 201.

The system can detect loops by examining if the receiving node is already in the paths. For example, assume node 203 is a parent of node 202. Then node 202 will have a path (202, 203). When node 203 is added as a child to node 202, parent node 202's path (202, 203) will be added to node 203. Node 203 will detect that itself is already in the paths. Thus, loop is detected. It is up to the system designer to decide loop is a valid option.

Propagating the changes to all descendants may take time. In a concurrent system, some descendants may not be the descendants anymore before the changes are propagated. For example, node 205 may be removed from node 204 before the above changes are propagated to node 205. That is perfectly OK. Because node 204 is not the ancestor of node 205 anymore, node 204's new ancestors doesn't affect node 205's ancestors. Each node's paths do need to be changed atomically. Different nodes' paths can be changed concurrently. There is no need to coordinate the changes among different nodes.

Each node can maintain an incoming change queue to accept changes from all its parents. There is no need to coordinate the changes from different parents. But the changes from the same parent needs to be in order.

When group 203 is removed from group 202, it is similar to group 203 is added to group 202. The only difference is that group 202's paths are removed from group 203's paths and the changes propagate to group 203's descendants recursively. Essentially undo all the changes of the add operation.

Choosing paths as changes seems clumsy. But its advantages become clear when a node is removed from its parent. For the same example of removing node 203 from node 202 after node 203 is added, if we simply use ancestors (node 202, 201) as changes, removing node 203 from node 202 will remove node 201 from node 204's ancestor list. This is wrong as there is still another path (206, 201) to make node 201 as an ancestor of node 204.

Choosing paths as changes solves this problem. Each node removal only removes its own paths. For example, removing node 203 from node 202 removes node 204's path of (203, 202, 201). The path (206, 201) is still intact. Thus node 201 is still one of node 204's ancestors.

So far, we illustrated how to update the affected nodes' ancestors when a child node is added to or removed from a parent node. As the child and parent relationship is many to many, there is no difference to update the affected nodes' descendants when a child node is added to or removed from a parent node. It is the just the opposite of the operation: update the parent nodes based on the child's descendant paths recursively. This likely requires the system to maintain child-to-parent edges to find each child's parents.

Some hybrid is possible to optimize the system further. One example is to skip generating ancestors for users. The rationale is that a group may have a large number of users. Propagate all the ancestor changes to all affected users may take time. Instead, to check if user A is a transitive member of a group B, the system breaks the operation to two steps. Step 1, get the parents of user A, parents_of_a. Step 2, check if group B is in the ancestors of parents_of_a.

Although several embodiments of approaches have been shown and described, it will be apparent to those of ordinary skill in the art that a number of changes, modifications, or alterations to the approaches as described may be made. Changes, modifications, and alterations should therefore be seen as within the scope of the methods and mechanisms described herein. It should also be emphasized that the above-described embodiments are only non-limiting examples of implementations.

1. A system for managing groups and users, comprising:
a. A cluster of computers that store a graph of groups and users. A group is a collection of groups and/or users. A group or a user can be included in multiple groups. When group A includes group B, there is a pointer/edge from A to B to mean A includes B. Optionally there is a pointer/edge from B to A to mean that B is a member of A. Both users and groups are nodes of the graph.
b. Each node has a list of paths to reach other nodes. The paths can be to its ancestors or to its descendants.
c. The computers accept group membership changes by adding/removing a group or user to/from another group. They update the affected nodes' ancestor paths or descendant paths so that each node's ancestors or descendants are updated to reflect the graph's reachability.
d. With each node's near real-time ancestors/descendants information, the system can answer if user A is in group B efficiently. Thus, the system can serve as a critical component of the access control system to determine if a user is allowed to act on a resource.

2. The system as recited in claim 1, wherein the computers are further configured to maintain each node's ancestor paths or descendant paths.
a. To maintain the ancestor paths: when group A or user A is added to a group B, B's ancestor paths are added to A and A's descendants recursively. When group A or user A is removed from group B, B's ancestor paths are removed from A and A's descendants recursively.
b. To maintain the descendant paths: when group A or user A is added to group B, A's descendant paths are added to B and B's ancestors recursively. When group A or user A is removed from group B, A's descendant paths are removed from B and B's ancestors recursively.
c. When an ancestor/descendant path is added to a node, the node can detect loops by detecting if itself is already in the path.
d. All nodes' changes can be executed concurrently. Each node's changes can be queued. Changes from the same parent or child need to be in order. Changes from different parents or children can be out of order.

3. The system as recited in claim 1, wherein the computers are further configured to maintain each node's ancestors or descendants by getting the unique nodes in the ancestor paths or descendant paths.

4. The system as recited in claim 1, wherein the computers are further configured to answer the question if user A is a transitive member of group B. This can be answered by checking if user A is in the descendants of group B, or checking if group B is in the ancestors of user A.

5. The system as recited in claim 1, wherein the computers are further configured to optionally skip generating the ancestor paths for users or skip generating the descendant paths that end at a user.
a. If users have no ancestors, to check if user A is a transitive member of a group B, the system breaks the operation to two steps. Step 1, get the parents of user A, parents_of_a. Step 2, check if group B is in the ancestors of parents_of_a.
b. If users are not in the groups' descendants, to check if user A is a transitive member of a group B, the system breaks the operation to three steps. Step 1, get the parents of user A, parents_of_a. Step 2, get the descendants of group B, descendants_of_b. Step 3, check if the intersection of parents_of_a and descendants_of_b is not empty.
